(19) United States
(12) Patent Application Publication
(10) Pub. No.: US 2014/0282632 A1
(43) Pub. Date: Sep. 18, 2014

(54) USING AUDIO DATA TO IDENTIFY AND RECORD VIDEO CONTENT

(71) Applicant: ECHOSTAR TECHNOLOGIES L.L.C., Englewood, CO (US)

(72) Inventors: Christofer Hardy, Cheyenne, WY (US); Thomas A. Yarborough, Cheyenne, WY (US)

(73) Assignee: ECHOSTAR TECHNOLOGIES L.L.C., Englewood, CO (US)

(21) Appl. No.: 13/802,274

(22) Filed: Mar. 13, 2013

(51) Int. Cl. H04N 21/24

(52) U.S. Cl. CPC H04N 21/24
USPC 725/1; 725/18

(57) ABSTRACT

Methods and apparatus are disclosed for identifying audiovisual content, such as a movie or television show, based on audio data of the show and then presenting options to a user for the identified content, including recording that content on the user's digital video recorder for later viewing.

### BACKGROUND

1. Technical Field

The present disclosure relates to systems and methods to identify audiovisual content based on audio data recorded by a smartphone from a device presenting content, and then present options to a user for the identified content, including recording that content on the user's Digital Video Recorder (DVR).

2. Description of the Related Art

The ability to identify music based on audio data, such as an audio clip, is well known in the industry. There are multiple products and services that provide this ability, such as Shazam, Tunatic, Midomi and others. For example, a user can record audio data of music playing on a radio or television, music being performed live, or music being sung or hummed. These services will query databases and search for the best matches for known recordings for the recorded data. These matches are then returned to the user and include additional information such as song name, artist, and other related information. In some cases, this information can be posted directly to a user's Facebook page or Twitter account. These services are generally targeted to users who know bits and pieces of a song and want to identify the title, author and recording artist.

### BRIEF SUMMARY

The present disclosure proposes systems and methods to allow a user to identify audiovisual content based on a recorded audio data, such as an audio clip, and to be offered options for further steps based on that identified content. Examples of options include but are not limited to setting up a video recording timer to record the original source of the content, purchasing a full version that includes the content, receiving available background information on the content such as information contained in the IMDB database, receiving a coupon for the advertised product if the content is an advertisement, making reservations at the advertised restaurant, or sharing the content information on the user's Facebook or Twitter account.

This concept provides for the use of audiovisual content to identify movies and television shows that are playing by recording audio data, having the movie or show identified, and then giving the user options for the content, such as recording the movie or show on a DVR. Frequently, a person may be away from home and see audiovisual content being presented that is of interest. For example, the person may be at a friend's house, at an airport, at a shopping mall, or at a gas station where a video monitor is running at the pump. Presentation displays at these locations may be showing a movie or a series, or an advertisement for a movie or show that the user would like to record. The user would record audio data of the displayed content, have that content identified, and user asked if the user would like to record that content on their DVR or set top box for future viewing.

### BRIEF DESCRIPTION OF THE SEVERAL VIEWS OF THE DRAWINGS

FIG. 1 is a context diagram showing a user recording audio data and sending the data to the system to be identified and recorded.

FIG. 2 is a diagram showing several embodiments of the sources of audio files and type of content from which audio data can be recorded.

FIG. 3 is a diagram showing an embodiment of method steps for a mobile device application and a server application, where the mobile device captures audio data that is sent to the server which returns matched content and content options available for the user to the user's mobile device.

FIG. 4 is a diagram showing one embodiment of the sample options that a user may perform with the matched content.

### DETAILED DESCRIPTION

FIG. 1 shows diagram 400 which is one embodiment of a context diagram of the disclosed system and method. A user 4 is listening to and watching content presented on display device 2. Display device 2 in some embodiments may be a television, a radio, video content being streamed on an internet-coupled device, and the like. Display device 2 might be located at the user's home, at a friend's home, in a hotel room, hotel lobby, an airport lounge, a shopping mall, a TV lounge in a dorm room, or other location. While the user 4 is listening to the presented content, the user may be interested in recording it for later viewing, or receiving more information related to the content. The user 4 would use smartphone 6 to record audio data of the content, which may be in the form of an audio clip. In some embodiments smartphone 6 may be a tablet, a music player, or any other device that can capture audio data and send it to another device.

In some embodiments, an application running on smartphone 6 will capture audio data, process it and send it to server application12 to be processed. In some embodiments, server application12 may run on a central control system device 10, which in some embodiments may be a headend of a program broadcast facility or other central location. In other embodiments server application12 may run on a set top box 8, or may be distributed into various modules and run among multiple devices. Server application 12 receives audio data from the user and examines the content database 14 for matches between audio data received from user 4 and the audio components of the content stored in the content database 14. In some embodiments, content database 14 may be implemented across multiple databases running on multiple machines. Server application 12 will receive the matched content and then will query the content options database 16 to determine those options the identified user is allowed to perform with the matched content. For example, if the matched content is a movie and central control system 10 determines that the user's service subscription allows the user access to the movie, the server application 12 will provide the user the option to record the movie on the user's DVR which may be a part of the user's set top box 8.

In some embodiments, the content options database 16 may be a part of and reside on a central control system 10, or it may be implemented across multiple databases running on multiple machines. In one or more embodiments, content options database 16 is updated by a content options server 18. Content options server 18, in some embodiments, may be updated by the central control system 10 with user-specific permissions for each piece of content, for example whether the user's video subscription service agreement allows pre-viewing or downloading of the content.

Other embodiments of a content options server 18 include a paid subscription agreement for content owners such as HBO, Showtime, ABC, NBC, CBS, AMC, concert promoters, or advertisers that enter into a paid arrangements to allow a user to perform additional options with the owner's content. If the content is an advertisement for a movie or series, the user may request that movie or series episode to be recorded on a set top box, to be purchased off-line in a DVD box set, or to have information about the content sent to the user's smartphone 6. If the content is an advertisement for a product or service, the user might request that a coupon for the product or service be sent to the user's smartphone 6. If the content is an advertisement for a restaurant, the user might request that a menu be downloaded to the user's smartphone 6 or request reservations for the restaurant. If the content is an advertisement for a theater performance, the user might request to purchase tickets for the performance.

FIG. 2 shows diagram 410 depicting several embodiments of the sources of audio files and type of content from which audio data could be recorded by user 4 using smartphone device 6. A presentation device may be a standard TV that is displaying a broadcast TV show or series episode 22 that is a standard public broadcast picked up on an antenna 23. The user may be offered to record the TV show or series in its entirety, record specific episodes, episodes not yet viewed, or shows related to the TV show or series within the user's subscription plan that the user may be interested in recording.

The presentation device may be coupled to a set top box 8 and be showing a concert or an advertisement for a concert 24. The user may be offered to record the concert, record a future concert by the same artist, or may have the option to purchase tickets for a future concert by the same artist or similar genre that is held within the user's geographic area.

The presentation device may be showing an advertisement for a consumer product 26 on an internet-coupled computer 17. The user may be offered a coupon to purchase the product at a store within the user's local area, or may be offered to record future concerts or events sponsored by the advertiser.

The presentation device may be a large screen movie theater showing a movie in progress 28. The user may have taken their smartphone to the movie theater and while watching the movie held up the phone to record a particular song or scene. The user may be offered the option to begin recording the movie immediately or to schedule a recording of the movie the next time it is played. The user may also be offered the opportunity to purchase the movie in a download form or DVD box set.

The presentation device may be showing an advertisement for a non-commodity item, for example clothing 30. Or the user may be listening to audio content over a radio 25. Here the user may be offered a discount or coupon for the clothing item, or information on store locations and pricing within the user's geographic area.

FIG. 3 shows diagram 420 showing one embodiment of method steps for a mobile device application 40 and a server application 41. The mobile device application 40 runs on a smartphone device 6 of user 4. In one embodiment the application will first record audio data from a display device 42 by the user holding the smart phone device next to the speaker of the video display device. The next step is to send the audio data to the server application 44 that processes audio data and identifies relevant content.

The next step on the server application 41 is to receive the audio data from the user 52. Once the audio data has been received, the next step to compare the audio data to the content database to find a content match 54 is performed. At this step the server interacts with content database 14 to identify matched content by analyzing the audio portions of content. At the next step, the server will retrieve the available options for the user to perform with the matched content 56. At this step, the server interacts with the content options database 16, which has been updated with the content options process 18, to determine what the user may do with the content based on user subscriptions, content owner subscriptions, and other information. In the next step, the server application will send the options to the user 58 to the user's smartphone 6.

The next step, on the mobile device application 40, is to receive the matched content information and available content options 46 on the user's smartphone device 6. The mobile device application will then prompt the user for options to perform 48 regarding the matched content. Once the user has selected the options the application will send the options to the server 50.

The server application 41 will then receive the selected options from the user 60 and then execute the selected options 62, for example by setting a DVR timer to record the content, or to send associated coupons to the user's smartphone device 6.

FIG. 4 shows diagram 430 showing one embodiment of the sample options a user may perform with matched content 66. These examples include setting up video recording timer to record the matched content at a set top box; to purchase the matched content either via download or off-line, for example as a DVD boxed set; receive a coupon or other discount for the advertised content; purchase tickets if the content is advertising an event; make reservations if the content is advertising a restaurant; receive background information available for the content, such as artist information, movie location information, venue information, and the like; or share the content information on the user's Facebook or Twitter account.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
a processing module configured to:
receive an audio data file,
analyze the audio data file to determine content associated with the audio data file,
determine the set of actions that can be taken based on the content,
output the set of actions to the user for display on a mobile communication device,
receive the selected actions from the mobile communication device, and
perform the selected actions.

2. A system according to claim 1, wherein the element of perform the selected actions further comprises:
determine if the user has permissions to record the content; and
record the content on a DVR associated with the user if the user has permissions to record the content.

3. A system according to claim 1, wherein the element of perform the selected actions further comprises:
receive content purchase information from the user;
purchase the content; and
deliver the purchased content to the user.

4. A system according to claim 1, wherein the element of perform the selected actions further comprises:
receive ticket purchase information from the user;
purchase the ticket; and
deliver the purchased ticket to the user.

5. A system according to claim 1, wherein the element of perform the selected actions further comprises:
deliver information about the content to the user.

6. A system according to claim 1, wherein the element of perform the selected actions further comprises:
deliver a coupon to the user.

7. A system according to claim 6, wherein the element of deliver a coupon to the user further comprises:
push an electronic version of the coupon to the mobile communication device.

8. A method comprising:
receiving an audio data file;
analyzing the audio clip to determine content associated with the audio data file;
determining a set of actions that can be taken by the user based on the content;
outputting the set of actions to the user for display on a mobile communication device;
receiving the selections of the actions from the mobile communications device; and
performing the selected actions.
